(19) United States
(12) Patent Application Publication
(10) Pub. No.: US 2018/0034132 A1
(43) Pub. Date: Feb. 1, 2018

(54) ELECTRONIC DEVICE

(71) Applicant: KYOCERA Corporation, Kyoto (JP)

(72) Inventor: Junya TAKAHASHI, Yokohama-shi (JP)

(73) Assignee: KYOCERA Corporation, Kyoto (JP)

(21) Appl. No.: 15/658,828

(22) Filed: Jul. 25, 2017

(30) Foreign Application Priority Data
Jul. 27, 2016 (JP) 2016-147553

(51) Int. Cl. H01Q 1/24; H01Q 9/00; H01Q 5/30; H01Q 1/48

(52) U.S. Cl. CPC H01Q 1/242; H01Q 1/48; H01Q 9/00; H01Q 5/30

(57) ABSTRACT

An electronic device that reduces deterioration of the antenna characteristics of an antenna corresponding to a plurality of communication bands is provided. An electronic device includes an antenna corresponding to a plurality of communication bands, a conductive member, a GND terminal, a first circuit, a second circuit having an impedance lower than that of the first circuit and a switching circuit. The first circuit and the second circuit can each connect the conductive member and the GND terminal. The switching circuit switches a circuit connecting the conductive member and the GND terminal between the first circuit and the second circuit depending on the communication band for use.

### CROSS REFERENCE TO RELATED APPLICATION

This application claims priority to and the benefit of Japanese Patent Application No. 2016-147553 filed on Jul. 27, 2016, the entire contents of which are incorporated herein by reference.

### TECHNICAL FIELD

The present disclosure relates to an electronic device provided with an antenna corresponding to a plurality of communication bands.

### BACKGROUND

Electronic devices having communication functions, such as mobile phones or smartphones, have been known.

### SUMMARY

An electronic device according to one embodiment of the present disclosure includes an antenna corresponding to a plurality of communication bands, a conductive member, a GND terminal, a first circuit, a second circuit having an impedance lower than that of the first circuit and a switching circuit. The first circuit and the second circuit can each connect the conductive member and the GND terminal. The switching circuit switches a circuit connecting the conductive member and the GND terminal between the first circuit and the second circuit depending on the communication band for use.

### BRIEF DESCRIPTION OF THE DRAWINGS

In the accompanying drawings:

FIG. 1 is a perspective view of an electronic device according to one embodiment;

FIG. 2 is a diagram of an internal structure of the electronic device's lower part viewed from back;

FIG. 3 is a schematic diagram of a circuit group connecting a conductive member and a substrate;

FIG. 4 is a circuit diagram schematically illustrating a circuit group connecting the conductive member and the substrate;

FIG. 5 is a diagram illustrating a position of a connection of the conductive member;

FIG. 6 is a diagram illustrating an antenna gain of the electronic device in communication using a single band of 700 MHz;

FIG. 7 is a diagram illustrating an antenna gain of the electronic device in communication using a single band of 800 MHz;

FIG. 8 is a diagram illustrating an antenna gain of the electronic device in communication using a single band of 2 GHz;

FIG. 9 is a diagram illustrating an antenna gain of the electronic device in a simultaneous multiband communication; and

FIG. 10 is a functional block diagram of a component that controls operation of the electronic device;

FIG. 11 is a diagram illustrating the setting information stored in a memory of the electronic device;

FIG. 12 is a flow chart illustrating an operation of the electronic device.

### DETAILED DESCRIPTION

For example, an antenna built in a mobile communication terminal and having multi-band characteristics has been known. Miniaturization of electronic devices has occasionally been desired. However, miniaturization of an electronic device may decrease the distance between an antenna and a conductive member disposed around the antenna and may block electromagnetic waves, and thus antenna characteristics may be reduced. Thus, reduction in deterioration of antenna characteristics has been desired for the electronic devices known in the art.

It is an object of the present disclosure to provide an electronic device that reduces deterioration of antenna characteristics of an antenna corresponding to a plurality of communication bands.

According to an electronic device of one embodiment of the present disclosure, deterioration of the antenna characteristics of an antenna corresponding to a plurality of communication bands is reduced.

One embodiment will be described below with reference to drawings.

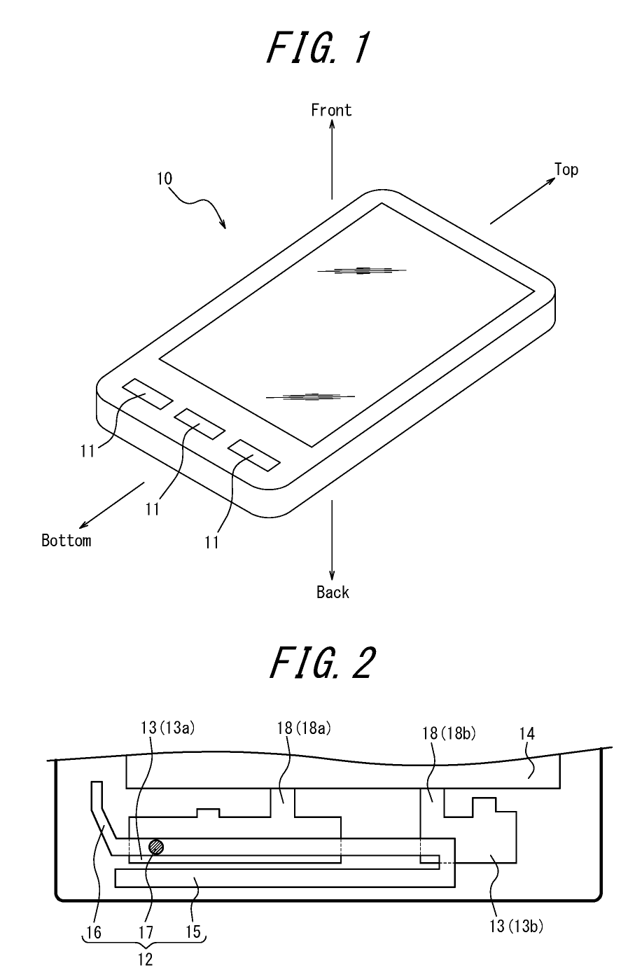

An electronic device 10 according to one embodiment will be described with reference to FIG. 1. In one embodiment, the electronic device 10 is a smartphone, for example. In the other embodiment, the electronic device 10 may include any device having a communication function, such as a personal computer (PC), a mobile phone, a tablet terminal and a game machine. For example, the electronic device 10 illustrated in FIG. 1 has three physical buttons 11 in the lower part on its front side.

An internal structure of the electronic device 10 around an antenna 12, which is built in the electronic device 10, will be described with reference to FIG. 2. FIG. 2 illustrates the antenna 12 built in the lower part of the electronic device 10, two conductive members 13 and a substrate 14. Hereinafter the two conductive members 13 are referred to also as a first conductive member 13a and a second conductive member 13b if needed.

The antenna 12 is a multiband antenna corresponding to a plurality of communication bands. In one embodiment, the antenna 12 corresponds to three types of communication bands including 700 MHz band, 800 MHz band and 2 GHz band. The antenna 12 has a first antenna element 15 corresponding to 700 MHz band and 800 MHz band and a second antenna element 16 corresponding to 2 GHz band.

In one embodiment, the electronic device 10 provided with the antenna 12 can communicate with four types of communication systems including communication using a single band of 700 MHz, communication using a single band of 800 MHz, communication using a single band of 2 GHz and simultaneous multiband communication in which above three communication bands are simultaneously used. In the other embodiment, the electronic device 10 may communicate with a communication system in which any number of above communication bands may be simultaneously used. The first antenna element 15 and the second antenna element 16 extend from a feeding point 17 in directions different from each other. The antenna 12 may have not only the above described configuration but also may have any configurations capable of corresponding to a plurality of communication bands.

In one embodiment, the conductive member 13 is a key flexible printed circuit (FPC) that transmits input signals for the physical button 11 to the substrate 14. A terminal 18 with a plurality of wiring patterns passing thereover is extendedly provided to the conductive member 13. The conductive member 13 is connected to the substrate 14 through the terminal 18. The wiring pattern includes a ground (GND) wiring pattern for grounding and an output wiring pattern for outputting input signals for the physical button 11. The GND wiring pattern is connected to a first GND terminal provided to the substrate 14. The output wiring pattern is connected to the input terminal of the substrate 14 that receives input signals for the physical button 11. Hereinafter a path by which the conductive member 13 and the first GND terminal of the substrate 14 are connected through the terminal 18 is referred to also as a first connection path. In the other embodiment, the conductive member 13 is not limited to a key FPC, and may be any conductive and grounded member.

The conductive member 13 is disposed near the antenna 12. Near the antenna 12 means that the distance between the antenna 12 and the conductive member 13 is small enough to cause deterioration of the antenna characteristics, such as antenna gain, in a practical use due to the effects of electromagnetic waves blocked by the grounded conductive member 13 and capacitive coupling between the antenna 12 and the conductive member 13. For example, the conductive member 13 disposed near the antenna 12 may deteriorate the antenna characteristics to less than the predetermined performance. In the example illustrated in FIG. 2, the antenna 12 and the conductive member 13 are disposed so that they are overlapped with each other in the thickness direction of the electronic device 10. The area of the region where the antenna 12 and the first conductive member 13a are overlapped with each other is larger than the area of the region where the antenna 12 and the second conductive member 13b are overlapped with each other. Thus, the first conductive member 13a may have a greater effect on the antenna characteristics than the second conductive member 13b may have.

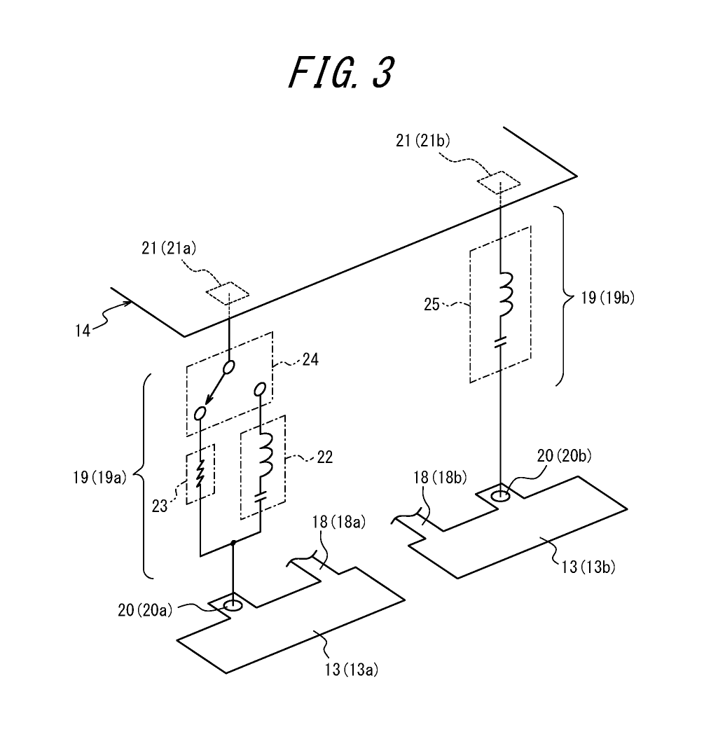

In one embodiment, as illustrated in FIG. 3, for example, the conductive member 13 and the substrate 14 are connected by the above described first connection path and the second connection path 19 which is different from the first connection path, respectively. This configuration reduces deterioration of the antenna characteristics caused by the conductive member 13. The second connection path 19 and reduction in deterioration of the antenna characteristics may be described in detail later.

Various elements required for operating the electronic device 10, such as a memory and a processor described later, are disposed on the substrate 14. For example, the above described first GND terminal and input terminal and a second GND terminal 21 described later are disposed on the substrate 14.

The second connection path 19 connecting the conductive member 13 and the substrate 14 is described in detail with reference to FIG. 3. In FIG. 3, the first connection path is not illustrated for visibility.

A second connection path 19a of the first conductive member 13a is a path that connects a connection 20a provided on the first conductive member 13a and a second GND terminal 21a provided on the substrate 14, as illustrated in FIG. 3, for example. The connection 20a is an exposed portion of GND wiring patterns of the first conductive member 13a, for example, and is only needed to be electrically connected with the GND wiring patterns. The position of the connection 20a on the first conductive member 13a will be described later. The second connection path 19a includes a first circuit 22, a second circuit 23 and a switching circuit 24.

The first circuit 22 is a resonance circuit including an inductor and a condenser connected in series. The first circuit 22 has a high impedance in a predetermined communication band. A high impedance means a large impedance value. For example, the impedance of the first circuit 22 in the first communication band of a plurality of communication bands corresponding to the antenna 12 is larger than that of the first circuit 22 in the second communication band thereof. In one embodiment, the first communication band is 2 GHz band and the second communication band is 800 MHz band. The first circuit 22 can connect the connection 20a of the first conductive member 13a and the second GND terminal 21a of the substrate 14 depending on the operation of the switching circuit 24 described later.

The second circuit 23 is a circuit including a conductor or a resistor. The second circuit 23 has the frequency characteristics of impedance which is different from that of the first circuit 22. In one embodiment, the second circuit 23 has an impedance lower than that of the first circuit 22. The low impedance means that an impedance value is small. Specifically, the impedance of the second circuit 23 in 800 MHz band is lower than the impedance of the first circuit 22 in 800 MHz band. The second circuit 23 can connect the connection 20a of the first conductive member 13a and the second GND terminal 21a of the substrate 14 depending on the operation of the switching circuit 24 described later.

The switching circuit 24 includes two switching terminals and one common terminal. The switching circuit 24 includes a switch that can switch between either one of the two switching terminals to be electrically connected to the common terminal. In one embodiment, two switching terminals of the switching circuit 24 are connected to the first circuit 22 terminal and the second circuit 23 terminal, respectively. The second GND terminal 21a of the substrate 14 is connected to the common terminal of the switching circuit 24. The other terminals of the first circuit 22 and the second circuit 23 are respectively connected to the connection 20a of the first conductive member 13a. In the other embodiment, the connection 20a may be connected to the common terminal of the switching circuit 24 and the second GND terminal 21a may be connected to each of the other terminals of the first circuit 22 and the second circuit.

The switching circuit 24 switches the circuit connecting the connection 20a of the first conductive member 13a and the second GND terminal 21a of the substrate 14 between the first circuit 22 and the second circuit 23 depending on the communication band for use. A specific operation of the switching circuit 24 depending on the communication band for use will be described later.

The second connection path 19b of the second conductive member 13b is a path that connects the connection 20b provided on the second conductive member 13b and the second GND terminal 21b provided on the substrate 14 through a third circuit 25. The connection 20b is an exposed portion of the GND wiring pattern of the second conductive member 13b, for example, and is only needed to be electrically connected with the GND wiring pattern. The position of the connection 20b on the second conductive member 13b will be described later.

The third circuit 25 is a resonance circuit having an inductor and a condenser connected in series. The third circuit 25 has a high impedance in a predetermined communication band. For example, the impedance of the third circuit 25 in 2 GHz band is higher than that of the third circuit 25 in 800 MHz band among the communication bands corresponding to the antenna 12. The configuration of the third circuit 25 may be the same as that of the above described first circuit 22. One of the terminals of the third circuit 25 is connected to the connection 20b of the second conductive member 13b and the other terminal is connected to the second GND terminal 21b of the substrate 14.

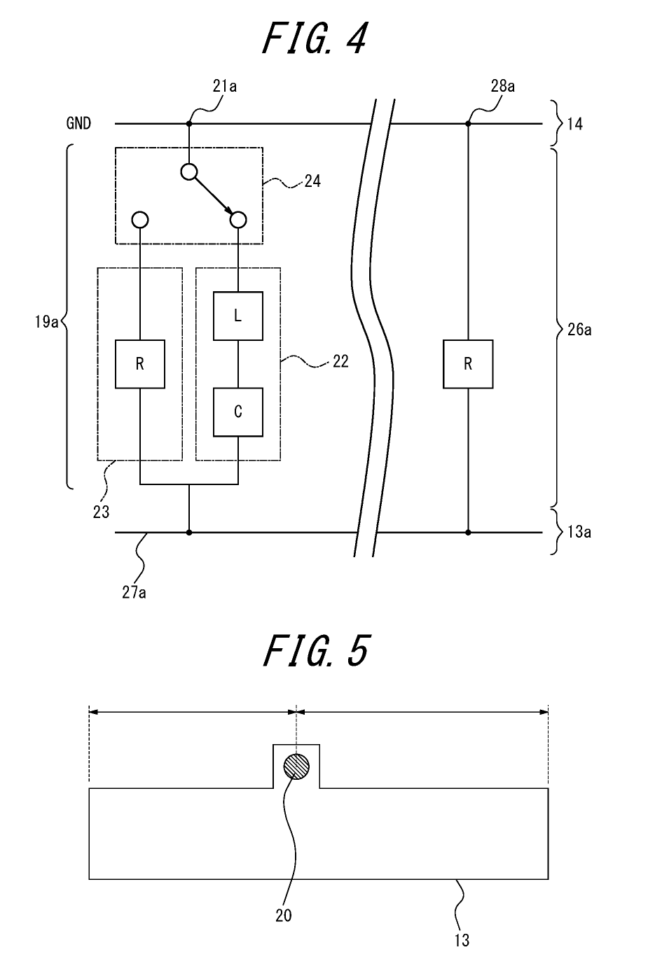

A circuit configuration in which the first conductive member 13a and the substrate 14 are connected through the first connection path 26a and the second connection path 19a will be described with reference to FIG. 4. The first connection path 26a connects the GND wiring pattern 27a of the first conductive member 13a and the first GND terminal 28a of the substrate 14. The resistance R illustrated on the first connection path 26a in FIG. 4 is a resistance, such as a conductor and a resistor.

Hereinafter the state where the connection 20a and the second GND terminal 21a are connected through the first circuit 22 of the second connection path 19a is referred to as a first connection state and the state where the connection 20a and the second GND terminal 21a are connected through the second circuit 23 is referred to as a second connection state.

When the second connection path 19a is in the first connection state, the connection 20a and the second GND terminal 21a are connected through an inductor and a condenser disposed in series. The first connection path 26a and the second connection path 19a serve as a parallel resonance circuit that connects the first conductive member 13a and the GND terminal of the substrate 14.

According to the experimental data described later, when the second connection path 19a is in the first connection state, the antenna gain in communication using a single band of 2 GHz and simultaneous multiband communication is improved compared to that in the second connection state. As described above, the first circuit 22 has a relatively high impedance in 2 GHz band. When the impedance of the second connection path 19a is sufficiently high, the first conductive member 13a is electrically separated when viewed from the antenna 12 in communication using 2 GHz band. Thus, it is assumed that deterioration of antenna characteristics due to the effects of the first conductive member 13a is reduced.

Meanwhile, when the second connection path 19a is in the second connection state, the connection 20a and the second GND terminal 21a are connected through the resistance R. The resistance R illustrated on the second connection path 19a in FIG. 4 is a resistance, such as a conductor or a resistor.

According to the experimental data described later, when the second connection path 19a is in the second connection state, the antenna gain in communication using a single band of 700 MHz and communication using a single band of 800 MHz is improved compared to that in the first connection state. In communication using a single band of 700 MHz and communication using a single band of 800 MHz, when the second connection path 19a is in the first connection state where its impedance is relatively high, it is assumed that the first conductive member 13a that is electrically separated when viewed from the antenna 12 and the first antenna element 15 of the antenna 12 are capacitively coupled. When the first conductive member 13a is capacitively coupled with the first antenna element 15, the electrical length of the first antenna element 15 varies, and thus the antenna characteristics may be deteriorated in communication using a single band of 700 MHz and communication using a single band of 800 MHz. Meanwhile, as described above, the second circuit 23 has an impedance lower than that of the first circuit 22 in 800 MHz band. Thus when the second connection path 19a is in the second connection state, it is assumed that deterioration of antenna characteristics may be reduced in communication using a single band of 700 MHz and communication using a single band of 800 MHz.

The position of the connection 20 on the conductive member 13 will be described with reference to FIG. 5. In FIG. 5, the terminal 18 is not illustrated for visibility. The length from the connection 20 to the end of the conductive member 13 may be other than an integer multiple of quarter wavelength of the frequency in a plurality of communication bands to which the antenna 12 corresponds. In one embodiment, the length may be a physical length or an electrical length. In this configuration, block of electromagnetic waves by the conductive member 13 is reduced, and thus deterioration of antenna characteristics may further be reduced. In the other embodiment, a plurality of connections 20 may be provided to the conductive member 13. In this case, the length between any two of the connections 20 may be other than an integer multiple of a quarter wavelength of the frequency in a plurality of communication bands to which the antenna 12 corresponds.

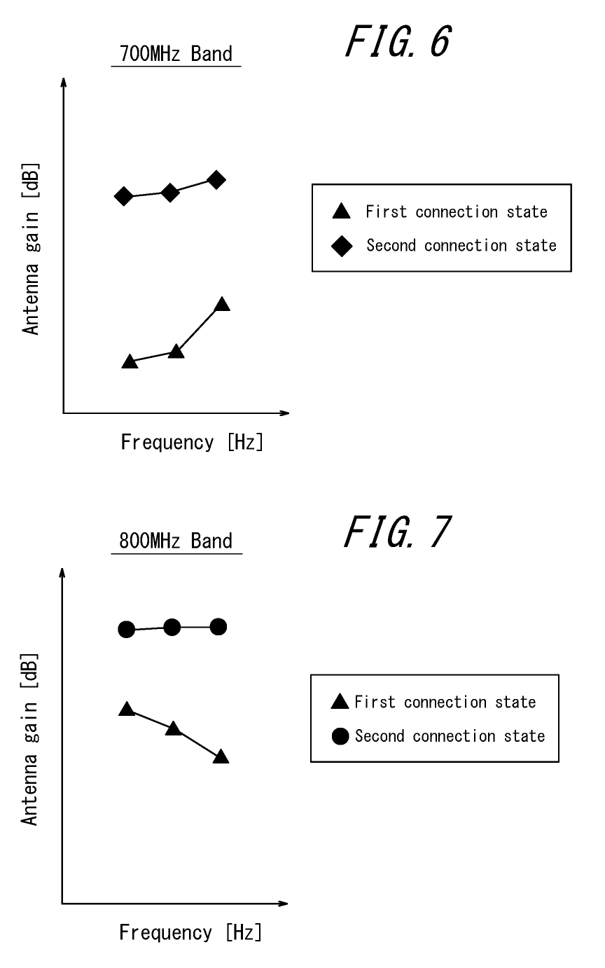

The experimental data of the antenna characteristics in the first conductive member 13a depending on the connection state of the second connection path 19a will be described with respect to FIGS. 6 to 9. In the graphs illustrated in FIGS. 6 to 9, the horizontal axis represents the frequency of electromagnetic waves transmitted by the electronic device 10 and the vertical axis represents the antenna gain.

FIG. 6 illustrates the antenna gain in communication using a single band of 700 MHz. As obvious from FIG. 6, the antenna gain of the second connection path 19a of the first conductive member 13a is larger when it is in the second connection state than that in the first connection state. Thus, in communication using a single band of 700 MHz, the second connection path 19a of the first conductive member 13a may preferably be in the second connection state, that is, in the state where the first conductive member 13a and the second GND terminal 21a of the substrate 14 are connected through the second circuit 23.

FIG. 7 illustrates the antenna gain in communication using a single band of 800 MHz. As obvious from FIG. 7, the antenna gain of the second connection path 19a of the first conductive member 13a is larger when it is in the second connection state than that in the first connection state. Thus, in communication using a single band of 800 MHz, as with communication using a single band of 700 MHz, the second connection path 19a of the first conductive member 13a may preferably be in the second connection state.

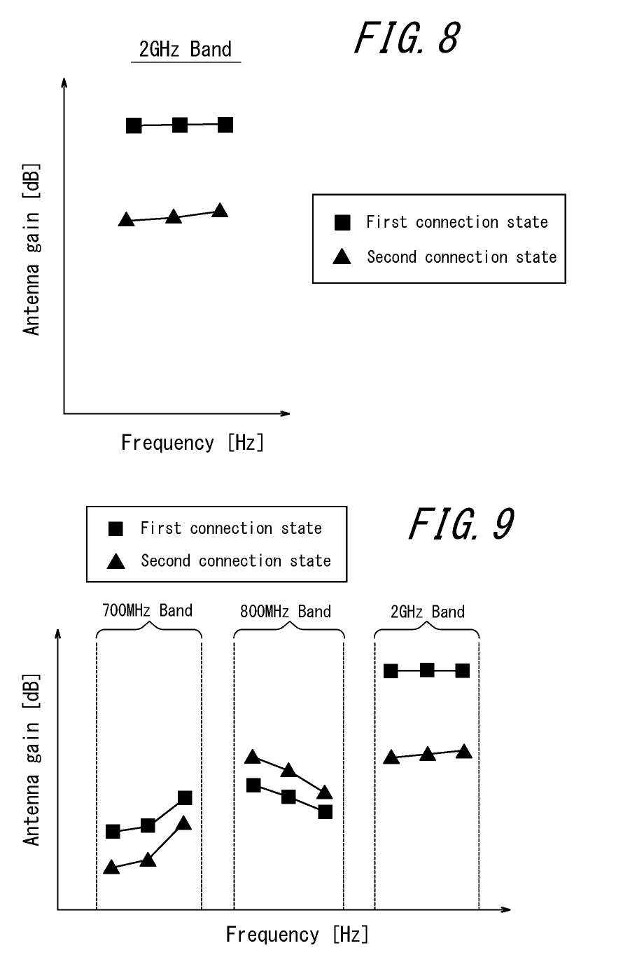

FIG. 8 illustrates the antenna gain in communication using a single band of 2 GHz. As obvious from FIG. 8, the antenna gain is larger when the second connection path 19a of the first conductive member 13a is in the first connection state than that in the second connection state. Thus, in communication using a single band of 2 GHz, the second connection path 19a of the first conductive member 13a may preferably be in the first connection state, that is, in the state where the first conductive member 13a and the second GND terminal 21a of the substrate 14 are connected through the first circuit 22.

FIG. 9 illustrates the antenna gain in simultaneous multiband communication. As obvious from FIG. 9, the antenna gain in 700 MHz band and 2 GHz band is larger when the second connection path 19a of the first conductive member 13a is in the first connection state than that in the second connection state. Meanwhile, the antenna gain in 800 MHz band is smaller when the second connection path 19a of the first conductive member 13a is in the first connection state than that in the second connection state. However, reduction in the antenna gain in 800 MHz band is within an allowable range in a practical use. Thus, in simultaneous multiband communication, as with the communication using a single band of 2 GHz, the second connection path 19a of the first conductive member 13a may preferably be in the first connection state.

In one embodiment, in communication using a single band of 700 MHz and communication using a single band of 800 MHz, the second connection path 19a of the first conductive member 13a is dynamically switched to the second connection state. Meanwhile, in communication using a single band of 2 GHz and simultaneous multiband communication, the second connection path 19a of the first conductive member 13a is dynamically switched to the first connection state.

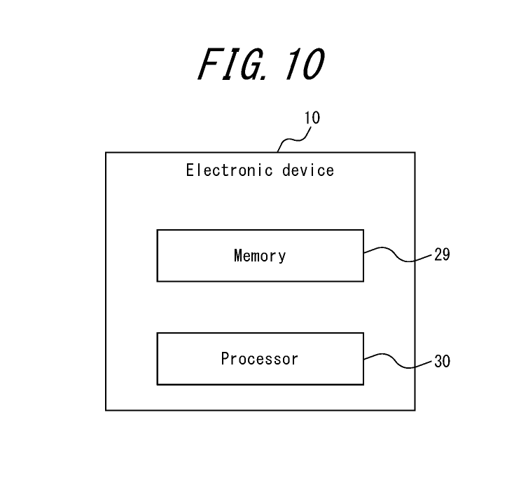

The configuration of the electronic device 10 that dynamically switches the connection state of the second connection path 19a of the first conductive member 13a will be described with reference to FIG. 10. The electronic device 10 includes a memory 29 and a processor 30.

The memory 29 includes a primary storage device and a secondary storage device, for example. The memory 29 may include a semiconductor memory, a magnetic memory, or an optical memory, for example. In one embodiment, the memory 29 stores various information and programs required for operating the electronic device 10.

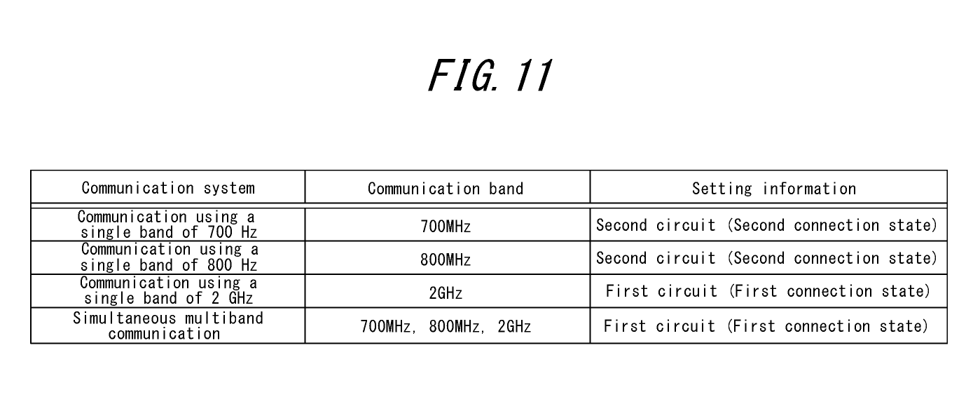

For example, the memory 29 stores multiple pieces of setting information used for controlling the switching circuit 24. In one embodiment, each piece of setting information indicates a circuit that connects the first conductive member 13a and the second GND terminal 21a of the substrate 14. In the other embodiment, each piece of setting information may indicate the connection state of the second connection path 19a of the first conductive member 13a. As illustrated in FIG. 11, each piece of setting information is associated with the communication system of the electronic device 10 and the communication band used for the communication system. In one embodiment, communication using a single band of 700 MHz band and communication using a single band of 800 MHz are each associated with the setting information indicating the second circuit 23. Meanwhile, communication using a single band of 2 GHz and simultaneous multiband communication are each associated with the setting information indicating the first circuit 22.

The processor 30 includes one or more general purpose processors that read a specific program to implement a specific function or one or more dedicated processors for a specific processing. The processor 30 controls the entire operation of the electronic device 10.

For example, the processor 30 controls the operation of the switching circuit 24 and switches the circuit connecting the first conductive member 13a and the second GND terminal 21a of the substrate 14 between the first circuit 22 and the second circuit 23 depending on the communication band for use. Specifically, the processor 30 detects the communication band employed by the communication system for use. In one embodiment, the processor 30 detects the communication band used in any one of the communication systems, such as communication using a single band of 700 MHz, communication using a single band of 800 MHz, communication using a single band of 2 GHz and simultaneous multiband communication. The processor 30 reads the setting information corresponding to the detected communication band from the memory 29. The processor 30 switches the circuit connecting the first conductive member 13a and the second GND terminal 21a of the substrate 14 to the circuit indicated by the read out setting information. Switching of the circuit is performed by driving a switch included in the switching circuit 24.

With this configuration, the switching circuit 24 connects the first conductive member 13a and the second GND terminal 21a of the substrate 14 through the second circuit 23 in communication using a single band of 700 MHz band and communication using a single band of 800 MHz. Meanwhile, the switching circuit 24 connects the first conductive member 13a and the second GND terminal 21a of the substrate 14 through the first circuit 22 in communication using a single band of 2 GHz and simultaneous multiband communication.

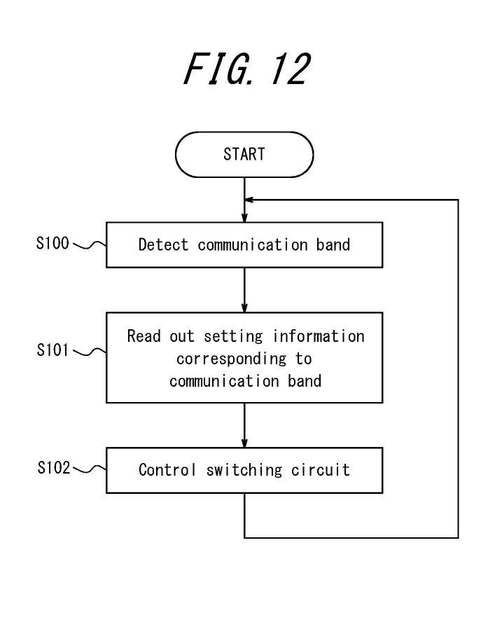

An operation of the electronic device 10 to dynamically switch the connection state of the second connection path 19a of the first conductive member 13a will be described with reference to FIG. 12.

In step S100, the processor 30 detects the communication band used by the communication system for use.

In step S101, the processor 30 reads out the setting information corresponding to the detected communication band from the memory 29.

In step S102, the processor 30 controls the switching circuit 24 and switches the circuit connecting the first conductive member 13a and the second GND terminal 21a of the substrate 14 between the first circuit 22 and the second circuit 23 depending on the setting information read out in step S101.

As described above, the electronic device 10 according to one embodiment switches the circuit connecting the first conductive member 13a and the second GND terminal 21a of the substrate 14 between the first circuit 22 and the second circuit 23 having an impedance lower than that of the first circuit 22 depending on to the communication band for use. This configuration allows for reduction in deterioration of the antenna 12 characteristics of the antenna corresponding to a plurality of communication bands.

Although the present disclosure has been described with reference to the accompanying drawings and embodiments, it is to be noted that various changes and modifications will be apparent to those skilled in the art based on the present disclosure. Therefore, such changes and modifications are to be understood as included within the scope of the present disclosure. For example, the functions and the like included in the members, steps, and the like may be reordered in any logically consistent way. Furthermore, members, steps, and the like may be combined into one or divided.

For example, specific configurations of the first circuit 22 and the second circuit 23 each having frequency characteristics of impedance different from each other are not limited to the above described embodiment. The specific configurations of the first circuit 22 and the second circuit 23 may each be adjusted depending on the shape and the size of the antenna 12 and the conductive member 13 and the positional correlation between them.

In the above described embodiment, the electronic device 10 is described assuming that it can communicate using four types of communication systems, such as communication using a single band of 700 MHz, communication using a single band of 800 MHz, communication using a single band of 2 GHz and simultaneous multiband communication using the above three communication bands. However, the communication system is not limited thereto. The electronic device 10 may communicate using communication systems, such as communication using a single band of 800 MHz, communication using a single band of 1.7 GHz, communication using a single band of 2 GHz and simultaneous multiband communication using these three communication bands. Moreover, the electronic device 10 may communicate using communication systems, such as communication using a single band of 800 MHz, communication using a single band of 1.5 GHz, communication using a single band of 2 GHz and simultaneous multiband communication using these three communication bands. Further, the electronic device 10 may communicate using communication systems, such as communication using a single band of 900 MHz, communication using a single band of 1.8 GHz, communication using a single band of 2.1 GHz and simultaneous multiband communication using these three communication bands. Also in these cases, the electronic device 10 may only need to switch the circuit connecting the first conductive member 13a and the second GND terminal 21a of the substrate 14 between the first circuit 22 and the second circuit 23 having an impedance lower than that of the first circuit depending on the communication band for use.

1. An electronic device, comprising
an antenna corresponding to a plurality of communication bands;
a conductive member;
a GND terminal;
a first circuit and a second circuit having an impedance lower than that of the first circuit, each circuit capable of connecting the conductive member and the GND terminal; and
a switching circuit configured to switch a circuit connecting the conductive member and the GND terminal between the first circuit and the second circuit depending on a communication band for use.

2. The electronic device according to claim 1, wherein an impedance of the first circuit in a first communication band of the communication bands is higher than an impedance of the first circuit in a second communication band of the communication bands.

3. The electronic device according to claim 2, wherein an impedance of the second circuit in the second communication band is lower than an impedance of the first circuit in the second communication band.

4. The electronic device according to claim 1, wherein the conductive member has at least one connection configured to be connected to the GND terminal through the first circuit or the second circuit, and a length from the connection to an end of the conductive member is other than an integer multiple of a quarter wavelength of a frequency of the communication bands.

5. The electronic device according to claim 2, wherein the conductive member has at least one connection configured to be connected to the GND terminal through the first circuit or the second circuit, and a length from the connection to an end of the conductive member is other than an integer multiple of a quarter wavelength of a frequency of the communication bands.

6. The electronic device according to claim 3, wherein the conductive member has at least one connection configured to be connected to the GND terminal through the first circuit or the second circuit, and a length from the connection to an end of the conductive member is other than an integer multiple of a quarter wavelength of a frequency of the communication bands.

7. The electronic device according to claim 4, wherein the conductive member has a plurality of the connections, and a length between any two of the connections is other than an integer multiple of a quarter wavelength of a frequency of the communication bands.

8. The electronic device according to claim 5, wherein the conductive member has a plurality of the connections, and a length between any two of the connections is other than an integer multiple of a quarter wavelength of a frequency of the communication bands.

9. The electronic device according to claim 6, wherein the conductive member has a plurality of the connections, and a length between any two of the connections is other than an integer multiple of a quarter wavelength of a frequency of the communication bands.
